(19) United States
(12) Patent Application Publication
(10) Pub. No.: US 2006/0165887 A1
(43) Pub. Date: Jul. 27, 2006

(54) METHOD OF COATING PHOTORESIST AND PHOTORESIST LAYER FORMED BY THE SAME

(76) Inventors: Yungyao Lee, Tainan County (TW); Vector Wang, Taichung City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/907,860

(22) Filed: Apr. 19, 2005

(30) Foreign Application Priority Data
Jan. 21, 2005 (TW) 94101773

(51) Int. Cl. B05D 3/12; B32B 3/00

(52) U.S. Cl. 427/240; 428/172; 428/66.7

(57) ABSTRACT

A method of coating photoresist is provided. A wafer is first provided and a spouting site is set up in a location within the circumference of the wafer. The spouting site is disposed at a distance from the center of the wafer. Next, the wafer is spun and a solvent is simultaneously dispensed on the spouting site. After that, photoresist agent is dispensed to the center of a wafer through a spout and then the photoresist agent and the solvent are spun around to spread out. Because a ring of solvent is dispensed on the wafer before spouting photoresist agent at the center of the wafer, the photoresist agent will be diluted when the photoresist agent and the solvent are being spread out. As a result, the layer of photoresist outside the original circle of solvent is thinner than the layer of photoresist inside the circle.

### CROSS-REFERENCE TO RELATED APPLICATION

This application claims the priority benefit of Taiwan application serial no. 94101773, filed on Jan. 21, 2005. All disclosure of the Taiwan application is incorporated herein by reference.

### BACKGROUND OF THE INVENTION

1. Field of the Invention

The present invention relates to a method of coating photoresist. More particularly, the present invention relates to a method of coating photoresist and a photoresist layer formed by the same.

2. Description of the Related Art

In general, semiconductor production requires many steps and involves quite complicated processes. Among all the processes in semiconductor fabrication, photolithography is one of the most critical processes. The three major steps involved in performing a photolithographic process include photoresist coating, photo-exposure and chemical development. Furthermore, the next step after each photolithographic process has been carried out is using the patterned photoresist layer as a mask to etch a film or a substrate underneath the photoresist layer or implant ions into the film or the substrate. To facilitate subsequent photolithographic process, the conventional photoresist coating desires the photoresist layer to be as smooth as possible. However, some of the currently developed semiconductor devices may have certain different requirements. For example, one type of semiconductor device called ‘trench type dynamic random access memory (DRAM)’ utilizes a trench to serve as a DRAM capacitor. In the process of fabrication, a uniformly thick layer of photoresist is deposited into the trench to serve as a mask for an etching operation. However, during the etching process, it is very hard to prevent a loading effect and will result in the etching rate near the center of the wafer greater than that in the peripheral area of the wafer. Consequently, the depth of photoresist in trenches at the peripheral area is greater than at the canter area so that the depth of trench recesses will vary considerably across the wafer. With a view to this problem, a process capable of producing a photoresist layer that varies in thickness across different areas of the wafer is in great demand.

### SUMMARY OF THE INVENTION

Accordingly, at least one objective of the present invention is to provide a method of coating photoresist capable of controlling the thickness of the photoresist layer in different areas.

At least a second objective of the present invention is to provide a photoresist layer having a variable thickness such that the thickness of the photoresist layer in both the thick and the thin area can be accurately controlled.

To achieve these and other advantages and in accordance with the purpose of the invention, as embodied and broadly described herein, the invention provides a method of coating photoresist. First, a wafer is provided and then a spouting site is set up in a location within the circumference of the wafer. The spouting site is disposed at a distance from the center of the wafer. Then, the wafer is spun and a solvent is simultaneously dispensed on the spouting site. After that, a photoresist agent is dispensed at the center of a wafer and then the photoresist agent and the solvent are spun around to spread out.

According to the preferred embodiment of the present invention, the process of dispensing solvent on the spouting site in the aforementioned method of coating photoresist includes controlling the spouting time of the solvent.

According to the preferred embodiment of the present invention, after dispensing solvent on the spouting site and before dispensing photoresist agent to the center of the wafer in the aforementioned method of coating photoresist further includes stopping spinning the wafer. Furthermore, the process of spouting photoresist agent at the center of the wafer includes controlling the delay time before the wafer starts spinning again.

According to the preferred embodiment of the present invention, after dispensing solvent on the spouting site and before dispensing photoresist agent to the center of the wafer in the aforementioned method of coating photoresist further includes spinning the wafer continuously. Furthermore, the process of spouting photoresist agent to the center of the wafer includes controlling the rotating speed of the wafer.

According to the preferred embodiment of the present invention, the process of spinning the photoresist agent and the solvent to be spread out in the aforementioned method of coating photoresist includes providing an acceleration.

According to the preferred embodiment of the present invention, the rotating speed of spinning the photoresist agent and the solvent around is greater than the rotating speed of dispensing the solvent on a spouting site.

The present invention also provides a method of forming a photoresist layer having a thicker area, a thinner area and an intermediate area between the two that decreases smoothly in thickness from the thicker area to the thinner area. The location of the intermediate area is controlled by the location of the aforementioned spouting site for dispensing the solvent. The extent of the intermediate area is controlled by the rotating speed when the solvent is dispensed on the spouting site.

According to the preferred embodiment of the present invention, the aforementioned thicker area is an area of the wafer inside the circumference marked out by the aforementioned spouting site with respect to the center of the wafer. Similarly, the thinner area is an area of the wafer outside the circumference marked out by the aforementioned spouting site with respect to the center of the wafer.

According to the preferred embodiment of the present invention, the thickness in the thicker area is controlled by the delay time before spinning the wafer and after dispensing photoresist agent to the center of the wafer.

According to the preferred embodiment of the present invention, the thickness of the thinner area is controlled by rotating speed of the wafer when the solvent is dispensed on the spouting site.

The present invention first sets a spouting site on the wafer. Then a combination of the spinning manners of the wafer and the spouting solvent forms a ring of solvent on the wafer. Then, photoresist agent is dispensed to the center of the wafer to form a photoresist layer having different thicknesses in different areas.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIGS. 1A and 1B are diagrams showing the processes of coating photoresist according to one preferred embodiment of the present invention.

FIG. 1C is a diagram showing a photoresist layer produced after the process in FIG. 1B.

FIGS. 2 through 4 are graphs showing the thickness profiles of the photoresist layer obtained from various experimentations according to the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

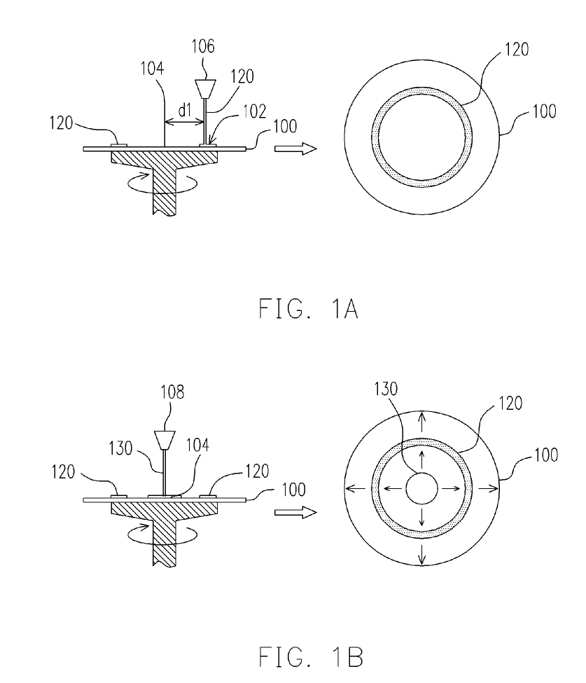

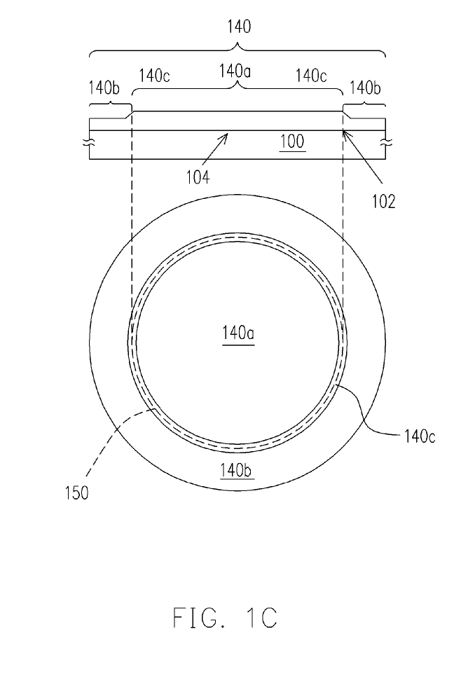

FIGS. 1A and 1B are diagrams showing the processes of coating photoresist according to one preferred embodiment of the present invention. FIG. 1C is a diagram showing a photoresist layer produced after the process in FIG. 1B.

First, as shown in FIG. 1A, a wafer 100 is provided and then a spouting site 102 is set up somewhere within the circumference of the wafer 100. The spouting site 102 is set up at a distance d1 from the center 104 of the wafer 100. Then, the wafer 100 is positioned on a rotating device such as a rotating plate 110. The wafer 100 is spun and a solvent 120 is simultaneously dispensed through a spouting device such as a spout 106 on the spouting site 102. The process of dispensing solvent 120 on the spouting site 102 may further include controlling the dispensing time of the solvent 120. The right side of FIG. 1A shows the top view of the wafer 100 after the solvent 120 has been dispensed. Wherein, the solvent 120 is circled as a ring.

As shown in FIG. 1B, a photoresist agent 130 is dispensed from a spouting device such as a spout 108 to the center 104 of the wafer 100 and then the photoresist agent 130 and the solvent 120 are spun around to spread out. To facilitate the spreading of the photoresist agent 130 and the solvent 120, it is common to add acceleration to help the photoresist agent 130 and the solvent 120 extend toward the outer circumference of the wafer 100. Furthermore, after dispensing the solvent 120 on the spouting site 102 as shown in FIG. 1A and before dispensing the photoresist agent 130 to the center 104 of the wafer 100 in FIG. 1B, the spinning wafer 100 can be stopped by selection. In addition, the process of dispensing the photoresist agent 130 to the center 104 of the wafer 100 may further include controlling the delay time for starting the spin of the wafer 100 again. Also, after dispensing the solvent 120 as shown in FIG. 1A and before dispensing the photoresist agent 130 in FIG. 1B, the wafer 100 may continue spinning by selection. Additionally, the process of dispensing the photoresist agent 130 to the center 104 of the wafer 100 may include controlling the rotating speed of the wafer 100. Furthermore, the rotating speed for spreading out the photoresist agent 130 and the solvent 120 is generally larger than the rotatiing speed when the solvent 120 is dispensed on the spouting site 102. Next, the photoresist agent 130 is ready for solidification process. Since this and subsequent processes are familiar to those with general knowledge in this field, hence the detailed description is omitted.

FIG. 1C is a diagram showing a photoresist layer produced according to the described processes. As shown in FIG. 1C, this type of photoresist layer 140 comprises a thicker area 140a and a thinner area 140b. The thicker area 140a is an area inside the circumference of a circle 150 marked out by the spouting site 102 relative to the center 104 of the wafer 100. On the contrary, the thinner area 140b is an area outside the circle 150. In addition, the photoresist layer 140 also includes an intermediate thickness area 140c between the thicker area 140a and the thinner area 140b whose thickness decreases smoothly from thicker area 140a to the thinner area 140b. The location of the intermediate thickness area 140c is dependent upon the location of the spouting site 102 and the spreading area of the intermediate thickness area 140c is dependent upon the rotating speed when the solvent 120 (refer to FIG. 1A) is dispensed on the spouting site 102. Furthermore, the thickness of the thicker area 140a can be controlled by the delay time for starting spinning the wafer when the photoresist agent 130 (refer to FIG. 1B) is dispensed to the center 104 of the wafer 100. Also, the thickness of the thinner area 140b can be controlled by the rotating speed of the wafer 100 when the solvent 120 (refer to FIG. 1A) is dispensed on the spouting site 102.

To verify the effectiveness of the present invention, the following results from experiments are provided.

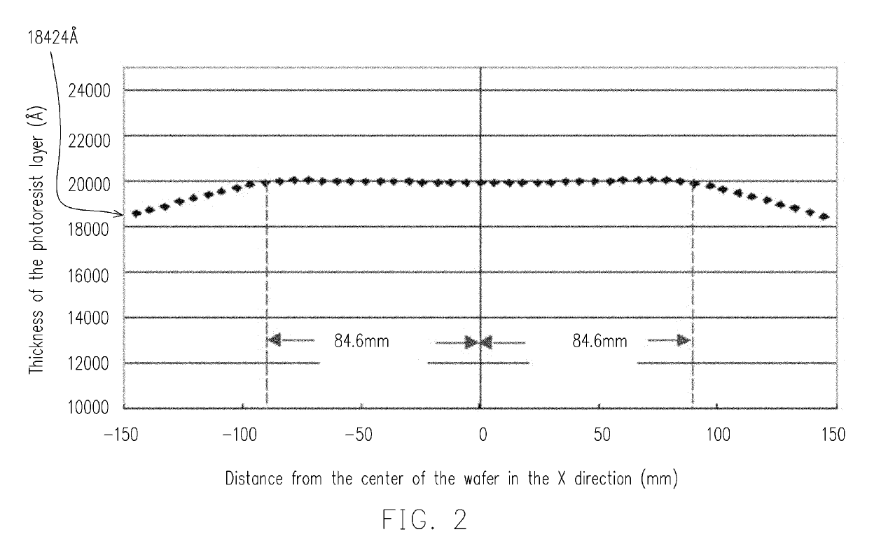

FIGS. 2 through 4 are graphs showing the thickness profiles of the photoresist layer obtained from various experimental examples according to the present invention.

First, as shown in FIG. 2, the thickness profile is obtained when a photoresist layer is formed on a 300 mm (12 inch) wafer using the method of the present invention. The spouting site is located at a position 85 mm from the center of the wafer and the rotating speed of the wafer when the solvent is dispensed from the spouting site is 50 rpm. Under these conditions, the intermediate thickness area of the photoresist layer is located outside a circle with a radius of about 84.6 mm and the thinner area has a thickness of about 18424 Å.

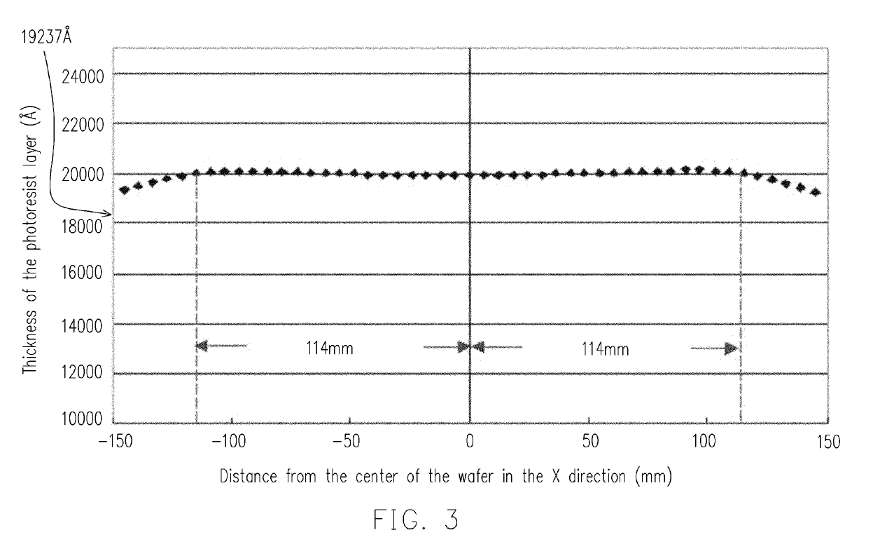

As shown in FIG. 3, the experimental setup is similar to the one in FIG. 2 except that the spouting site is set at a distance 114 mm from the center of the wafer. Under this condition, the intermediate thickness area is located outside a circle with a radius of about 114 mm. Accordingly, by changing the position of the spouting site, the location of the intermediate thickness area can be shifted.

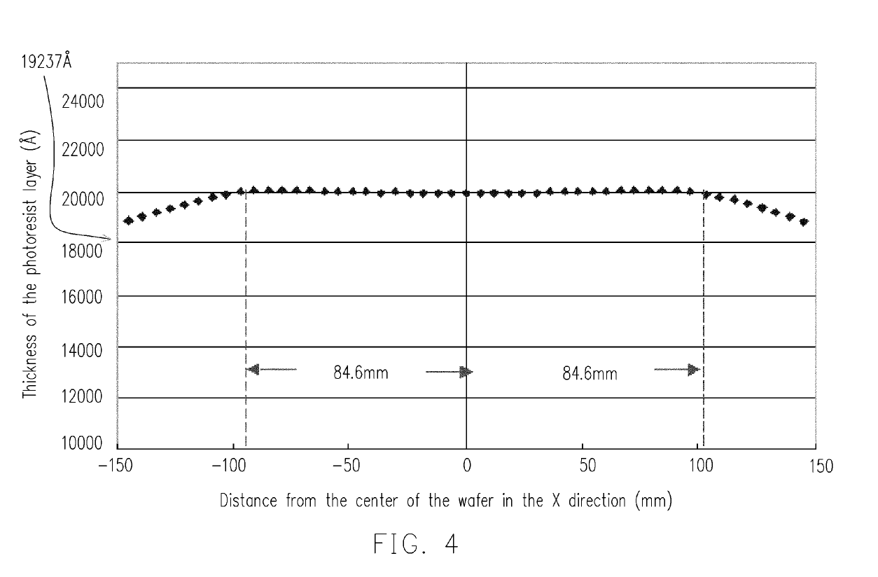

As shown in FIG. 4, the experimental setup is similar to the ones in FIGS. 2 and 3 except that the rotating speed of the wafer when the solvent is dispensed from the spouting site is 250 rpm. Under this condition, the intermediate thickness area of the photoresist layer is also located outside a circle with a radius of about 84.6 mm and the thinner area has a thickness of about 18883 Å. In other words, when the rotating speed of the wafer when the solvent is dispensed from the spouting side is reduced, the thickness of the thinner area of the photoresist layer will be reduced. Hence, the thickness of the thinner area can be controlled by adjusting the rotating speed of the wafer when the solvent is dispensed on the spouting site.

In summary, one major characteristic of the present invention is to establish a spouting site at a proper location on the wafer, set the wafer rotating at a proper speed and dispense solvent on the spouting site in an appropriate timing to produce a circle of solvent on the wafer. Next, the photoresist agent is dispensed to the center of the wafer. Hence, the thicknesses of the photoresist layer in different areas can be controlled. Through the aforementioned method, location and spreading area of the intermediate thickness area of the photoresist layer can be accurately controlled to meet the demands of various processing requirements or different types of devices.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method of coating photoresist, comprising the steps of:
providing a wafer;
setting up a spouting site within the circumference of the wafer, wherein the spouting site is located at a distance from the center of the wafer;
spinning the wafer and dispensing solvent on the spouting site;
dispensing a photoresist agent to the center of the wafer; and
spinning the photoresist agent and the solvent around to spread them out.

2. The method of claim 1, wherein the step of dispensing the solvent comprises controlling the time for spouting the solvent.

3. The method of claim 1, wherein after dispensing the solvent on the spouting site and before dispensing the photoresist agent to the center of the wafer, further comprises stopping spinning the wafer.

4. The method of claim 3, wherein the step of dispensing the photoresist agent to the center of the wafer further comprises controlling the delay time for starting spinning the wafer.

5. The method of claim 1, wherein after dispensing the solvent on the spouting site and before dispensing the photoresist agent to the center of the wafer, further comprises spinning the wafer continuously.

6. The method of claim 5, wherein the step of dispensing the photoresist agent to the center of the wafer further comprises controlling the rotating speed of the wafer.

7. The method of claim 1, wherein the step of spinning the photoresist agent and the solvent around further comprises providing an acceleration.

8. The method of claim 1, wherein the rotating speed for spreading out the photoresist agent and the solvent is greater than the rotating speed for dispensing the solvent on the spouting site.

9. A photoresist layer formed according to the method for coating photoresist in claim 1, having the following characteristics:
the photoresist layer comprises a thicker area, a thinner area and an intermediate area between the thicker area and the thinner area such that the thickness decreases smoothly from the thicker area to the thinner area;
the location of the intermediate thickness area can be set by the location of the spouting site; and
the spreading area of the intermediate thickness area can be set by the rotating speed of the wafer when the solvent is dispensed on the spouting site.

10. The photoresist layer of claim 9, wherein the thicker area is located inside the circle marked by the circumference of the spouting site relative to the center of the wafer.

11. The photoresist layer of claim 9, wherein the thinner area is located outside the circle marked by the circumference of the spouting site relative to the center of the wafer.

12. The photoresist layer of claim 9, wherein the thickness of the thicker area is controlled by the delay time for starting spinning the wafer after dispensing the photoresist agent to the center of the wafer.

13. The photoresist layer of claim 9, wherein the thickness of the thinner area is controlled by the rotating speed of the wafer when the solvent is dispensed on the spouting site.
